(19) United States
(12) Patent Application Publication
(10) Pub. No.: US 2008/0152907 A1
(43) Pub. Date: Jun. 26, 2008

(54) POLYANILINE CONDUCTIVE SOLUTION, AND A METHOD OF MANUFACTURING THEREOF

(75) Inventor: Chi-Shu Wei, Panchiao City (TW)

Correspondence Address: KNOBBE MARTENS OLSON & BEAR LLP, 2040 MAIN STREET, FOURTEENTH FLOOR, IRVINE, CA, 92614, US

(73) Assignee: TAIWAN TEXTILE RESEARCH INSTITUTE, Tu-chen City (TW)

(21) Appl. No.: 11/961,469

(22) Filed: Dec. 20, 2007

(30) Foreign Application Priority Data
Dec. 22, 2006 (TW) 95148599

(51) Int. Cl. H01B 1/12; H01B 5/00; C08G 73/00

(52) U.S. Cl. 428/379; 428/375; 528/422; 252/511; 528/391

(57) ABSTRACT

A composition of a polyaniline conductive solution includes an aniline monomer solution, an aqueous solution, and an oxidizing initiator. In the composition, the aniline monomer solution comprises at least one kind of aniline monomers. The aqueous solution comprises an organic acid salt and water. After the aniline monomer solution and the aqueous solution are mixed together, a mix solution is formed. Moreover, the oxidizing initiator is used for catalyzing the polymerization of the aniline monomers. Meanwhile, an application and a method of manufacturing the polyaniline conductive solution are also disclosed in the specification.

### CROSS-REFERENCE TO RELATED APPLICATIONS

This application claims priority to Taiwan Application Serial Number 95148599, filed Dec. 22, 2006, which is herein incorporated by reference.

### BACKGROUND OF THE INVENTION

1. Field of the Invention

The present invention relates to a conductive solution. More particularly, the present invention relates to a polyaniline conductive solution.

2. Description of the Related Art

Polyaniline doped with protons can be conductive, and therefore it is widely used after being prepared as a conductive solution. For example, the polyaniline conductive solution can provide electrostatic discharge (ESD), so that the solution can be applied to packing of electronics (e.g. chips). Moreover, carbon black can be added to the polyaniline conductive solution and then the solution can also be applied to the outside of fibers so that the fibers can be heated while a voltage is applied.

However, in the conventional method, the process of preparing polyaniline conductive solution is very complicated. Either polyaniline needs to be powdered before being dissolved in a solvent, or polyaniline needs to be mixed with a protonic acid by emulsification first, and then oil-water separation to obtain the polyaniline conductive solution in an organic phase. In addition to that, the conventional method sometimes results in the aggregation of carbon black due to the bad dispersion ability of carbon black in the polyaniline conductive solution prepared by the conventional method.

For the forgoing reasons, a simplified method is needed to prepare a polyaniline conductive solution and also improve dispersion of carbon black in the solution.

### SUMMARY OF THE INVENTION

The present invention is directed to a composition of a polyaniline conductive solution to simplify the conventional process.

It is therefore an aspect of the present invention to provide the composition of a polyaniline conductive solution, comprising an aniline monomer solution, an aqueous solution, and an oxidation initiator wherein the aniline monomer solution comprises at least one kind of aniline monomers and the aqueous solution comprises at least an organic acid salt and water. The aqueous solution is mixed with the aniline monomer solution to form a mixture solution. The oxidation initiator initiates the polymerization of the aniline monomers.

According to one embodiment of the present invention, the organic acid salt used is sodium dodecyl sulfate. The weight ratio of the aqueous solution to the aniline monomer solution is equal to or greater than 2. Moreover, the aniline monomer solution further comprises an organic solvent insoluble in water so that the weight ratio of the aniline monomer solution to the aqueous solution is equal to or greater than 2. The aqueous solution also comprises a protonic acid to dope the aniline monomers. The mole ratio of the protonic acid to the organic acid salt added is between 0 and 1.

It is another an aspect of the present invention to provide a method of preparing a polyaniline conductive solution. An aniline monomer solution is prepared first. On the side, an organic acid salt is added to water to form an aqueous solution. After that, the aniline monomer solution and the aqueous solution above are mixed to form a mixture solution. Finally, an oxidation initiator is added to the mixture solution to initiate the polymerization of the aniline monomers.

It is still another an aspect of the present invention to provide an electrically heated fiber, comprising a fiber core and a resin layer coated on the outside of the fiber core. The resin layer is made of a polyaniline conductive solution described above.

Compared with the conventional process, the process provided in the embodiment of the present invention not only eliminates the step of oil-water separation but also provided the polyaniline conductive solution with better electrothermal properties.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a flow chart of preparing a polyaniline conductive solution according to one embodiment of the present invention.

### DETAILED DESCRIPTION OF THE PREFERRED EMBODIMENT

Reference will now be made in detail to the present embodiments of the invention, examples of which are illustrated in the accompanying drawings. Wherever possible, the same reference numbers are used in the drawings and the description to refer to the same or like parts.

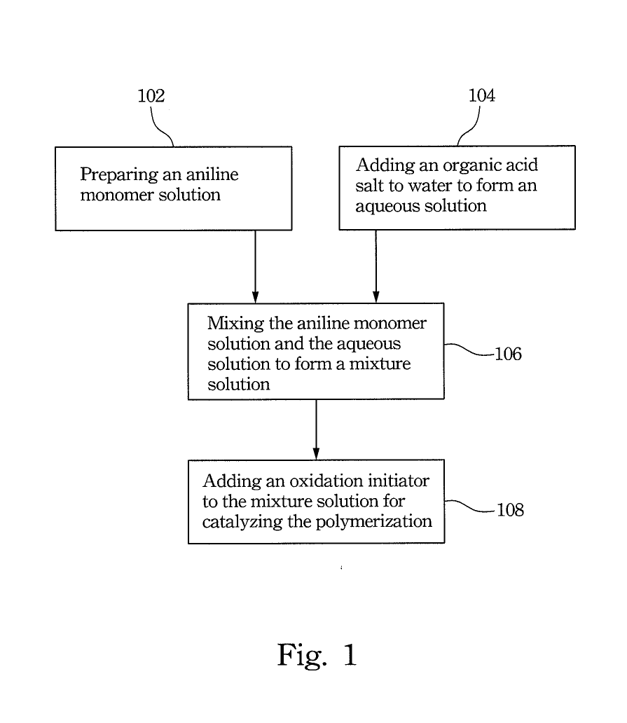

Refer to FIG. 1. FIG. 1 illustrates a flow chart of how a polyaniline conductive solution is prepared according to one embodiment of the present invention. First, an aniline monomer solution is prepared (step 102). The aniline monomer solution comprises at least one kind of aniline monomer, such as aniline, alkylaniline, alkoxyaniline, hydroxyaniline, nitroaniline, halogenoaniline, acidic group-substituted aniline or salts of any one of the aforesaid compound.

The aniline monomer solution further comprises an organic solvent insoluble in water, for example, dichloromethane, trichloromethane, trichloroethane, tetrachlorodifluoroethane, tetrachloromethane, benzene, methylbenzene, dimethylbenzene, carbon disulfide, pentane, or cyclohexane, mineral oil.

On the side, an organic acid salt is added to water to form an aqueous solution (step 104). The organic acid salt is alkyl sulfinate (RSO₂M), alkyl sulfite (ROSO₂M), alkyl sulfate (ROSO₃M), alkyl carbonate (ROCO₂M), alkoxy sulfite (ROOSO₂M), alkoxy sulfate (ROOSO₃M) or alkoxy carbonate (ROOCO₂M) wherein a carbon number of alkyl or alkoxy group is 5-20. The aqueous solution also comprises a protonic acid to dope the aniline monomers. The mole ratio of the added protonic acid to the added organic acid salt is between 0 and 1.

After that, the aniline monomer solution and the aqueous solution are mixed to form a mixture solution (step 106). Finally an oxidation initiator is added to the mixture solution to initiate the polymerization of the aniline monomers so that a polyaniline conductive solution is produced. (step 108). The oxidation initiator is selected from a group consisting of ammonium peroxysulfate, ammonium persulfate, potassium persulfate, potassium perchlorate, potassium chloride, potassium iodide, ferric chloride, fuming sulfuric acid, hydrogen peroxide, or ozone. The preparation process is presented in more detail in the exemplified embodiment as follows.

### (I) Preparation of Polyaniline Conductive Solution

First, 37 g of aniline was dissolved in 1000 g of methylbenzene to prepare an aniline monomer solution, and 30 g of sodium dodecyl sulfate was dissolved in 90 g of water to prepare an aqueous solution. After that, these two solutions were stirred for 4 hours so that a mixture solution was obtained. Next, 93 g of ammonium persulfate was added to the mixture solution to initiate the polymerization reaction. After the polymerization reaction, a polyaniline conductive solution was obtained.

In the embodiment of the present invention, polymerized aniline (i.e. polyaniline) became nano-scale particles. The organic acid salt, sodium dodecyl sulfate, not only doped the polyaniline to enhance conductivity but also improved the hydrophilicity of polyaniline so that the nano-scale of the polyaniline particles dispersed uniformly in the conductive solution.

### (II) Preparation of Electrically Heated Fiber

In another embodiment of the present invention, resin (e.g. silica gel) or carbon black were added to the polyaniline conductive solution prepared and then the solution was applied on the outside of the fiber. After solidification, the solution turned into a resin layer, and an electrically heated fiber was obtained. The material of the fiber core can be carbon, stainless steel, gold, silver, copper, iron, nickel or conductive alloy. Furthermore, according to different functions of the fiber, an infrared material, a minus ion material, or a combination thereof can be added to the conductive solution which is then applied on the outside of the fiber. In addition, to prevent the fiber from being exposed to water, a water proof material can be coated on the resin layer to form a water proof layer. The water proof material is, for example, polyurethane, silica gel, polyamide, polyimide, polyamide-imide, epoxy resin, poly(vinyl chloride), or polypropylene.

### (III) The Test of Carbon Black Dispersion and Conductivity

To verify whether the conductive solution prepared above has better carbon dispersing abilities or not, the same amount of carbon black was added to two different polyaniline conductive solutions respectively for a dispersing ability test wherein one of the conductive solution was prepared by the method above and the other one was prepared by the conventional oil-water separation method on the basis of U.S. Pat. No. 6,030,551. Meanwhile, to test electrothermal properties, the same amount of silica gel was also added to these two polyaniline conductive solutions respectively and a conductivity test was performed after the solution was baked. The test results were listed in the following table I.

TABLE I
test results of dispersion ability and conductivity

| | | Amount of | | |
|---|---|---|---|---|
| Method of | Carbon | Conductive | Silica | |
| Preparation | Black | Solution Used | Gel | Conductivity |
| (a) U.S. Pat. No. | 1 g | 20 g | 7 g | 4 × 10⁴ Ω/cm |
| 6,030,551 | | | | |
| (b) Embodiment I | 1 g | 4 g | 7 g | 4 × 10⁴ Ω/cm |

According to Table I, the conductive solution prepared by the conventional oil-water separation method (a) had poor carbon black dispersing ability. At least 20 g of solution (a) was needed to disperse 1 g of carbon black. However, under the same dispersion condition, only 4 g of the conductive solution prepared by the method of embodiment I (b) was needed to disperse carbon black uniformly and no aggregation occurred. Furthermore, the conductivity of the conductive solution (b) still maintained at 4×10⁴ Ω/cm, which is no big difference from that of the conductive solution (a).

### (IV) Heating Efficiency Test of the Electrically Heated Fiber

The following test is to verify whether the conductive solution of the embodiment I provides better heating efficiency to electrically heating fibers or not. The process of the test is described as follows. First, carbon black and resin were added to the conductive solution prepared on basis of the embodiment I. Then the solution was applied to fibers to manufacture the electrically heating fibers. After that, the heating efficiency test was performed. In this test, fibers with two different numbers of filaments were tested respectively and the fibers not coated with the conductive solution were used as the control. The results are shown in Table II.

TABLE II
heating efficiency test results of fibers

| | | Coated | | | | Highest |
|---|---|---|---|---|---|---|
| | | with | linear | | | Heating |
| | | Conductive | resistivity | Heating Rate | Voltage | Temperature |
| Filaments | Fiber | Solution | (Ω/10 cm) | (° C./30 sec) | Supplied (V) | (° C.) |
| 6000 | (c) | No | 10 | 3 | 12 | 32.0 |
| | (d) | Yes | 100 | 5 | 12 | 37.6 |
| 12000 | (e) | No | 10 | 3 | 12 | 38.0 |
| | (f) | Yes | 100 | 5 | 12 | 42.0 |
| | (g) | Yes | 10⁵⁻⁶ | 5 | 12 | 80.0 |

As shown in Table II, each bundle of fibers (c) and (d) consisted of 6000 filaments and each bundle of fibers (e), (f), and (g) consisted of 12000 filaments wherein the fibers (c) and (e) were not coated with conductive solution, but the fibers (d), (f) and (g) were. According to Table II, the fibers (d) and (f) have a faster heating rate which reached 5° C. in 30 seconds, compared with the test results of fibers (c) and (e). Moreover, the highest heating temperatures of the fibers (d) and (f) were 37.6° C. and 42° C. respectively, that is much higher than the highest heating temperatures of the uncoated fibers (c) and (e), 32° C. and 38° C. Comparing the test result of the fiber (f) with the fiber (d), when the linear resistivity of fibers are the same, the more the filaments are in each fiber, the higher the highest heating temperatures are. As to the fibers (f) and (g), they were prepared with the same conductive solution, carbon black, and resin but with different ratios to change the linear resistivity. According to the test results of the fibers (f) and (g), while the specification of the fibers were the same, as the linear resistivity increased, the highest heating temperatures were also raised, which can reach 80° C.

In view of above, the embodiment of the present invention simplifies the manufacturing process of polyaniline conductive solution, and the polyaniline conductive solution prepared not only has better ability of dispersing carbon black, but also enhance conductivity, and heating efficiency. Hence, it can be applied to materials for processing fibers or packing of electronics.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A composition of a polyaniline conductive solution, comprising:
an aniline monomer solution comprising at least one kind of aniline monomer;
an aqueous solution comprising at least an organic acid salt and water and being mixed with the aniline monomer solution to form a mixture solution; and
an oxidation initiator to initiate the polymerization of the aniline monomers.

2. The composition of claim 1, wherein the aniline monomers are aniline, alkylaniline, alkoxyaniline, hydroxyaniline, nitroaniline, halogenoaniline, acidic group-substituted aniline or salts of any one of the aforesaid compounds.

3. The composition of claim 1, wherein the oxidation initiator is selected from a group consisting of ammonium peroxysulfate, ammonium persulfate, potassium persulfate, potassium perchlorate, potassium chloride, potassium iodide, ferric chloride, fuming sulfuric acid, hydrogen peroxide, ozone and a combination thereof.

4. The composition of claim 1, wherein the organic acid salt is alkyl sulfinate (RSO₂M), alkyl sulfite (ROSO₂M), alkyl sulfate (ROSO₃M), alkyl carbonate (ROCO₂M), alkoxy sulfite (ROOSO₂M), alkoxy sulfate (ROOSO₃M) or alkoxy carbonate (ROOCO₂M) wherein a carbon number of alkyl or alkoxy group is 5-20.

5. The composition of claim 4, wherein the organic acid salt is sodium dodecyl sulfate.

6. The composition of claim 1, wherein the aniline monomer solution comprises an organic solvent insoluble in water to mix with the aniline monomers.

7. The composition of claim 6, wherein the organic solvent insoluble in water is selected from a group consisting of dichloromethane, trichloromethane, trichloroethane, tetrachlorodifluoroethane, tetrachloromethane, benzene, methylbenzene, dimethylbenzene, carbon disulfide, pentane, cyclohexane, mineral oil and a combination thereof.

8. The composition of claim 7, wherein the weight ratio of the aniline monomer solution to the aqueous solution is equal or greater than 2.

9. The composition of claim 1, wherein the weight ratio of the aqueous solution to the aniline monomer solution is equal or greater than 2.

10. The composition of claim 1, wherein the aqueous solution comprises a protonic acid for doping the aniline monomers.

11. The composition of claim 10, wherein the mole ratio of the protonic acid to the organic acid salt is from 0 to 1.

12. The composition of claim 10, further comprising a plurality of carbon blacks to improve electrothermal properties of the polyaniline conductive solution.

13. A method of preparing a polyaniline conductive solution, comprising:
preparing an aniline monomer solution;
adding an organic acid salt to water to form an aqueous solution;
mixing the aniline monomer solution and the aqueous solution to form a mixture solution; and
adding an oxidation initiator to the mixture solution for catalyzing the polymerization of the aniline monomers.

14. The method of claim 13, wherein the aniline monomer solution comprises at least one kind of aniline monomers.

15. The method of claim 14, wherein the aniline monomers are aniline, alkylaniline, alkoxyaniline, hydroxyaniline, nitroaniline, halogenoaniline, acidic group-substituted aniline or salts of any one of the aforesaid compound.

16. The method of claim 15, wherein the aniline monomer solution comprises an organic solvent insoluble in water.

17. The method of claim 16, wherein the organic solvent insoluble in water is selected from a group consisting of dichloromethane, trichloromethane, trichloroethane, tetrachlorodifluoroethane, tetrachloromethane, benzene, methylbenzene, dimethylbenzene, carbon disulfide, pentane, cyclohexane, mineral oil and a combination thereof.

18. The method of claim 17, wherein the weight ratio of the aniline monomer solution to the aqueous solution is equal or greater than 2.

19. The method of claim 13, wherein the weight ratio of the aqueous solution to the aniline monomer solution is equal or greater than 2.

20. The method of claim 13, wherein the oxidation initiator is selected from a group consisting of ammonium peroxysulfate, ammonium persulfate, potassium persulfate, potassium perchlorate, potassium chloride, potassium iodide, ferric chloride, fuming sulfuric acid, hydrogen peroxide, ozone and a combination thereof.

21. The method of claim 13, wherein the organic acid salt is alkyl sulfinate (RSO2M), alkyl sulfite (ROSO2M), alkyl sulfate (ROSO3M), alkyl carbonate (ROCO2M), alkoxy sulfite (ROOSO2M), alkoxy sulfate (ROOSO3M) or alkoxy carbonate (ROOCO2M) wherein a carbon number of alkyl or alkoxy group is 5-20.

22. The method of claim 21, wherein the organic acid salt is sodium dodecyl sulfate.

23. The method of claim 13, wherein the step of adding the organic acid salt into water comprises adding a protonic acid to the aqueous solution for doping the aniline monomers.

24. The method of claim 23, wherein the mole ratio of the protonic acid to the organic acid salt added is from 0 to 1.

25. The method of claim 13, further comprising stirring the mixture solution to emulsifying the mixture solution after the step of mixing the aniline monomer solution and the aqueous solution.

26. The method of claim 13, further comprising adding a plurality of carbon blacks to the mixture solution to improve the electro-thermal properties of the polyaniline conductive solution.

27. An electrically heated fiber, comprising:
a fiber core; and
a resin layer coated on the outside of the fiber core wherein the resin layer is made of a polyaniline conductive solution as in claim 1.

28. The fiber of claim 27, wherein the resin layer comprises an infrared material, an minus ion material, or a combination thereof.

29. The fiber of claim 27, further comprising a water proof layer covering on the outside of the resin layer.

30. The fiber of claim 29, wherein the water proof layer is made of a material selected from a group consisting of polyurethane, silica gel, polyamide, polyimide, polyamide-imide, epoxy resin, poly(vinyl chloride), polypropylene and a combination thereof.

31. The fiber of claim 27, wherein the fiber core is made of carbon, stainless steel, gold, silver, copper, iron, nickel or conductive alloy.
